(19) United States
(12) Patent Application Publication
(10) Pub. No.: US 2026/0299606 A1
(43) Pub. Date: Oct. 1, 2026

(54) TRANSPORT SYSTEM, CONTROL METHOD, AND MANUFACTURING SYSTEM

(71) Applicant: CANON KABUSHIKI KAISHA, Tokyo (JP)

(72) Inventor: HIDETADA NARAHARA, Kanagawa (JP)

(21) Appl. No.: 19/566,377

(22) Filed: Mar. 13, 2026

(30) Foreign Application Priority Data
Mar. 27, 2025 (JP) 2025-054119

(51) Int. Cl. G05D 1/65; B65G 54/02; G05D 1/222; G05D 107/70

(52) U.S. Cl. CPC G05D 1/65; B65G 54/02; G05D 1/222; G05D 2107/70

(57) ABSTRACT

A transport system includes a movable element, a transport unit including a plurality of transport modules, and a control unit configured to control the movable element along the transport unit. A respective transport velocity to transport the movable element is set in each of the plurality of transport modules, and the control unit is configured to generate a control profile for the movable element based on the respective transport velocity set in each of the plurality of transport modules.

### BACKGROUND

### Field of the Technology

The present disclosure relates to a transport system, a control method, and a manufacturing system.

### Description of the Related Art

A transport system has been generally known in a production line for assembling industrial products. Especially in a factory automated production line, the transport system has been used to transport workpieces such as components within the production line or between production lines. Additionally, there is also a case where the transport system is used as a transport apparatus in a process apparatus. As such a transport system, a transport system using a linear motor of a movable magnet type or a linear motor of a movable coil type has been already proposed in Japanese Patent Application Laid-Open No. 2018-158723.

Additionally, various kinds of techniques of allowing work performed by various kinds of process apparatuses and human work to coexist in a production line have also been proposed in late years.

In a case where the transport system as described in Japanese Patent Application Laid-Open No. 2018-158723 is applied to a production line including human work, consideration needs to be given to prevention of the transport system from causing harm to people. Meanwhile, operating the transport system at a safe velocity results in reduced efficiency of the production line.

### SUMMARY

According to an aspect of the present disclosure, a transport system includes a movable element, a transport unit including a plurality of transport modules, and a control unit configured to control the movable element along the transport unit. A respective transport velocity to transport the movable element is set in each of the plurality of transport modules, and the control unit is configured to generate a control profile for the movable element based on the respective transport velocity set in each of the plurality of transport modules.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram illustrating a transport system according to a first embodiment of the present disclosure.

FIGS. 2A to 2C are schematic configuration diagrams each illustrating a transport apparatus according to the first embodiment of the present disclosure.

FIG. 3 is a chart for describing operation of the transport system according to the first embodiment of the present disclosure.

FIGS. 4A to 4C are diagrams for describing operation of a carriage according to the first embodiment of the present disclosure.

FIG. 5 is a schematic configuration diagram illustrating a transport system according to a second embodiment of the present disclosure.

FIG. 6 is a schematic diagram illustrating an application according to a third embodiment of the present disclosure.

FIG. 7 is a schematic diagram illustrating the application according to the third embodiment of the present disclosure.

FIG. 8 is a schematic diagram illustrating an application according to a fourth embodiment of the present disclosure.

### DESCRIPTION OF THE EMBODIMENTS

### First Embodiment

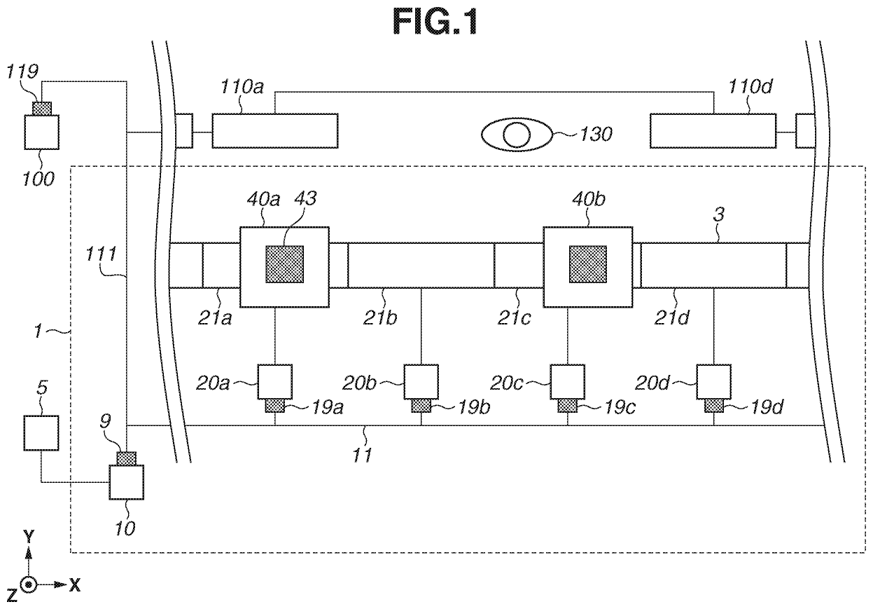

A first embodiment of the present disclosure will be described below with reference to FIGS. 1, 2A to 2C, 3, and 4A to 4C.

The following description will be given of each of a plurality of existing components by adding a lowercase alphabet to the end of a number as necessary to distinguish the components, and using a reference number composed of only a common number when there is no particular need to distinguish the components.

A transport system 1 according to the present embodiment will be described with reference to FIG. 1. FIG. 1 is a schematic diagram illustrating part of the transport system 1 including a transport unit 3, a carriage 40 as a movable element, a lower control unit 20, and an upper control unit 10. In FIGS. 1, 2A to 2C, 3, and 4A to 4C, assume that an X-axis is along a transport direction of the carriage 40, a direction perpendicular to a stand on which a transport module 21 is placed is a Z-axis, and an axis orthogonal to the X-axis and the Z-axis is a Y-axis. In the present specification, this coordinate system may be referred to as a global coordinate system.

The transport system 1 includes the transport unit 3 composed of a plurality of transport modules 21, and a plurality of lower control units 20. The transport modules 21 are connected to each other and arranged on the stand. The lower control units 20 are connected to the respective transport modules 21 and control the respective transport modules 21 to which the respective lower control units 20 are connected. Additionally, the transport system 1 includes the upper control unit 10 and a plurality of carriages 40. The upper control unit 10 controls the plurality of lower control units 20 via a transport network 11. The plurality of carriage 40 transports respective workpieces 43 on the transport unit 3.

The plurality of transport modules 21 each includes a stator including a coil, which will be described below. The carriage 40 includes a movable element including a permanent magnet, which will be described below. That is, the transport system 1 according to the present embodiment has a movable magnet type configuration.

The plurality of lower control units 20 each includes a lower external communication interface 19, and is communicably connected to the upper control unit 10 including an upper external communication interface 9 via the transport network 11. Each lower control unit 20 plays the role of controlling the transport module 21 to which the lower control unit 20 is connected, and performs driving control of a carriage 40 that is on the corresponding transport module 21 or a carriage 40 that has entered the corresponding transport module 21 based on a driving instruction transmitted from the upper control unit 10.

A console 5 is communicably connected to the upper control unit 10, as necessary. The console 5 is necessary mainly at the time of making a setting regarding the transport system 1, monitoring a state, or the like. For example, there is a software application such as a graphical user interface (GUI) in the console 5, and the order of connection of the transport modules 21, the number of carriages 40, an operation setting, and the like in the transport system 1 are set as parameters in the upper control unit 10. When the setting or the like ends, the console 5 may be disconnected.

The transport system 1 is used together with a plurality of process apparatuses 110a to 110d. The plurality of carriages 40 each receives motive power from the transport modules 21 to move along the transport unit 3, and transports a processing target (workpiece) 43 to each of the process apparatuses 110a to 110d. An apparatus control unit 100 includes an apparatus external communication interface 119. The process apparatuses 110a to 110d are connected to each other by a process apparatus network 111, and are controlled by the apparatus control unit 100. Additionally, the apparatus control unit 100 is connected to the upper control unit 10 via the apparatus external communication interface 119, and the apparatus control unit 100 and the upper control unit 10 exchange information.

The transport unit 3 illustrated in FIG. 1 is part of a whole transport path. For explanatory convenience, a description will be given by extraction of only four transport modules 21a to 21d, lower control units 20a to 20d, and two carriages 40a and 40b. The number of transport modules 21, the number of lower control units 20, and the number of carriages 40 are not limited thereto.

Here, assume that the process apparatuses 110a to 110d are arranged so as to correspond to the respective transport modules 21a to 21d for explanatory convenience. For example, the process apparatus 110a performs process processing on the carriage 40a on the transport module 21a.

An operator 130 performs collaborative work with the process apparatus 110, such as assembling or processing, on the workpiece 43 on the carriage 40 that is transported on the transport unit 3.

Since the transport system 1 is described in the present embodiment, a description of facilities or the like for performing the collaborative work is omitted.

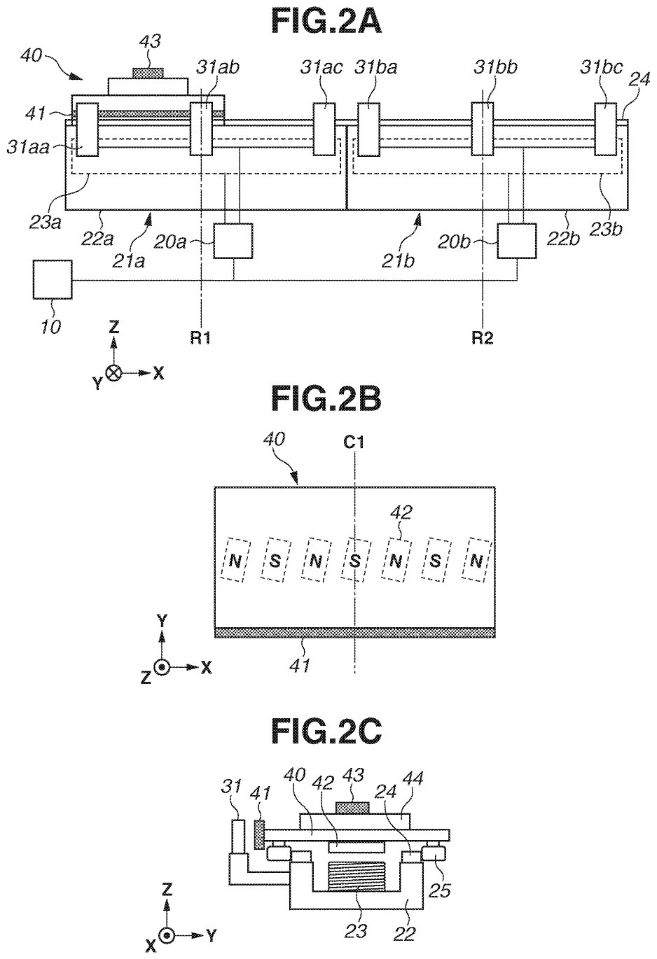

FIG. 2A illustrates two transport modules 21a and 21b and one carriage 40. A configuration regarding the transport modules 21a and 21b and the carriage 40 is described in detail with reference to FIGS. 2A to 2C.

FIG. 2A is a diagram illustrating the carriage 40 and the transport modules 21a and 21b when viewed from a Y-axis direction. FIG. 2B is a diagram illustrating only the carriage 40 when viewed from a Z-axis direction. Additionally, FIG. 2C is a diagram illustrating the transport module 21a and the carriage 40 when viewed from an X-axis direction.

As illustrated in FIGS. 2A and 2C, the transport module 21a includes a housing 22a, encoders 31aa to 31ac, a coil group 23a, and a guide rail 24, and is connected to the lower control unit 20a. Additionally, the transport module 21b includes a housing 22b, encoders 31ba to 31bc, a coil group 23b, and the guide rail 24, and is connected to the lower control unit 20b. In the present embodiment, the description is given of the example using the encoders 31aa to 31bc, but the configuration is not limited thereto. A known sensor can be used as long as it is capable of detecting the position of the carriage 40. Additionally, in the following description, the encoders 31a to 31c may be referred to as sensors 31a to 31c.

A power source, which is not illustrated, is connected to the lower control unit 20a. The number and installation positions of encoders 31aa to 31ac in the transport module 21a are adjusted as appropriate depending on the size of the carriage 40, the size of the transport module 21a, accuracy in detection of the position of the carriage 40, or the like. Additionally, the guide rail 24 may be shared and used by the housings 22a and 22b. The same applies to configurations of other transport modules 21.

As illustrated in FIGS. 2B and 2C, the carriage 40 includes a scale 41, a plurality of permanent magnets 42 (which may be referred to as a magnet row), a workpiece gripping mechanism 44, and a guide roller 25.

At this time, the guide roller 25 is only required to have a configuration capable of moving the carriage 40 in the X-axis direction, and may be constituted as a guide block.

The guide roller 25 in the carriage 40 is guided by the guide rail 24 in the transport module 21. The carriage 40 is driven by electromagnetic force generated between the carriage 40 and the coil group 23 attached to the housing 22, and is transported along the transport unit 3 (X-axis).

For example, the encoders 31a to 31c in the transport module 21a are attached at a plurality of positions of the housing 22a so that a gap between each of the encoders 31a to 31c and the scale 41 in the carriage 40 becomes constant.

The encoders 31a to 31c are attached with an appropriate interval so as to be capable of detecting the carriage 40 no matter where the carriage 40 is located in the transport module 21a.

The encoders 31a to 31c read a pattern of the scale 41 in the carriage 40, and detect the position of the carriage 40 in an X-direction (an X-position) as a relative position with respect to each of the encoders 31a to 31c. The encoders 31a to 31c then output information regarding the position of the carriage 40a to the lower control unit 20a. The lower control unit 20a is capable of knowing at which position of the corresponding transport module 21a the carriage 40 is located based on this information. The lower control unit 20a transmits the information to the upper control unit 10.

In the present embodiment, a description is given of an example in which the encoder 31 is of an absolute type and the scale 41 that can be read by an absolute type sensor is installed. However, the configuration is not limited thereto, and an encoder according to a known system of various kinds may be used.

For example, a center C1 of a width of the carriage 40 in the transport direction (X direction) is defined as a reference position, and the position of the carriage 40 is defined as coordinates of the reference position C1.

In control of the carriage 40, the upper control unit 10 controls the whole of the transport system 1 using one coordinate system (the above-mentioned global coordinate system). In contrast, the lower control units 20a and 20b perform control using individual coordinate systems respectively set to the lower control units 20a and 20b (hereinafter referred to as local coordinate systems).

Out of sensors provided in each transport module 21 that transmit a signal to the corresponding lower control unit 20, for example, the position of an encoder 31 located at the center of the transport module 21 is defined as a point of origin of the local coordinate system of the corresponding transport module 21.

R1 represents the position of the encoder 31ab in the global coordinate system and a point of origin of the transport module 21a. Similarly, R2 represents the position of the encoder 31bb in the global coordinate system and a point of origin of the transport module 21b.

The upper control unit 10 holds the position of the point of origin in the local coordinate system of each transport module 21. The lower control unit 20 applies current to the coil group 23 in the corresponding transport module 21 based on the driving instruction from the upper control unit 10 and controls an amount of the current. With this control, the lower control unit 20 transports the carriage 40 to a predetermined position on the corresponding transport module 21 at a predetermined velocity or stops the carriage 40.

Additionally, the lower control unit 20 is capable of detecting the entry of the carriage 40 from an adjacent transport module 21 into the corresponding transport module 21 with the encoders 31aa to 31bc in the corresponding transport module 21. The lower control unit 20 then controls the transport of the carriage 40 based on a control instruction from the upper control unit 10 since the carriage 40 that has entered the corresponding transport module 21 reaches the predetermined position of the corresponding transport module 21.

This predetermined position may be a boundary between the transport modules 21. Alternatively, the lower control unit 20 may control the carriage 40 when the encoder 31 in the corresponding transport module 21 reads the scale 41 in the carriage 40.

For example, assuming that the carriage 40 moves in a +X-axis direction in FIG. 2A, the lower control unit 20a controls the carriage 40 on the transport module 21a when the encoder 31aa in the transport module 21a reads the scale 41 in the carriage 40. Additionally, when the carriage 40 enters the transport module 21b and the encoder 31ba in the transport module 21b reads the scale 41 in the carriage 40, the lower control unit 20b controls the carriage 40 on the transport module 21b.

While the carriage 40 operates in the +X-axis direction in the example illustrated in FIG. 2A, the direction is not limited thereto. For example, the carriage 40 may operate in a-X-axis direction and move from the transport module 21b to the transport module 21a. Alternatively, the carriage 40 may move reciprocally between the transport module 21a and the transport module 21b.

When receiving the driving instruction from the upper control unit 10, the plurality of lower control units 20 each applies the driving instruction to the carriage 40 on the corresponding transport module 21 or the carriage 40 that has entered the corresponding transport module 21, and starts driving control of the carriage 40.

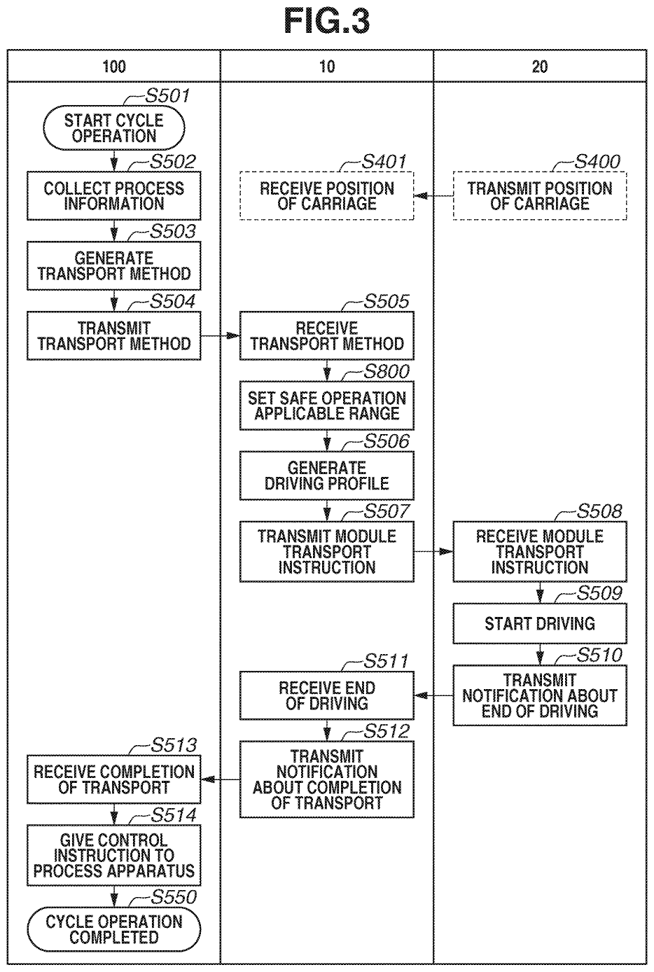

FIG. 3 is a timing chart of operation among the apparatus control unit 100, the upper control unit 10, and the lower control unit 20.

Generally, a process of manufacturing industrial products takes a form in which at the same time as a plurality of workpieces 43 is transported on the transport unit 3, the plurality of process apparatuses 110 arranged along the transport unit 3 in the process order sequentially processes the workpieces 43. A unit of work in transport of the workpieces 43 and processing performed by the process apparatus 110 is referred to as a “cycle operation”. By repetition of the cycle operation, a product is manufactured. Details of this cycle operation are now described with FIG. 3.

As steps that are executed asynchronously to a main sequence, there are steps S400 and S401. In step S400, the lower control unit 20 constantly acquires the position of the carriage 40 from the encoders 31 and transmits the position to the upper control unit 10. Additionally, in step S401, the upper control unit 10 constantly converts the position of each carriage 40 into a position in the global coordinate system, and holds and updates the position.

The main sequence is described below.

First, in step S501, the cycle operation starts. When the cycle operation starts, in step S502, the apparatus control unit 100 collects process information regarding the state of the workpiece 43 on each carriage 40 and the state of the process apparatus 110. In step S503, the apparatus control unit 100 generates a method of transporting the carriage 40 based on the collected process information. For example, if there is a workpiece 43 that has not been processed sufficiently on the carriage group composed of the plurality of carriages 40, the apparatus control unit 100 transports the workpiece 43 to a process of additionally performing processing. Alternatively, since the process aimed for collection includes transport, the method of transporting the carriage 40 is reviewed every one cycle operation.

In step S504, the apparatus control unit 100 transmits the method of transporting the carriage group composed of the plurality of carriages 40 to the upper control unit 10. In step S505, the upper control unit 10 receives the method of transporting the carriage group. In step S800, the upper control unit 10 sets the transport module 21 in which the carriage 40 is safely transported as a safe operation applicable range based on the position of human work and a number of the target transport module 21, which are preliminarily held in the storage unit.

In step S506, the upper control unit 10 uses the position information regarding each carriage 40 in step S401 to generate a trapezoid driving profile for each carriage 40 based on the method of transporting the carriage group. If the safe operation applicable range set in step S800 is included in a profile for the carriage 40 to be transported, the upper control unit 10 generates a driving profile in consideration of a safe velocity in a target section.

In step S507, the upper control unit 10 transmits the driving profile as a module transport instruction to the corresponding lower control unit 20 based on the position information regarding each carriage 40 in step S401.

In step S508, the lower control unit 20 receives the driving instruction.

In step S509, each lower control unit 20 starts driving control of the carriage 40. The lower control unit 20 starts transport of the carriage 40 on the corresponding transport module 21, or transports or stops the carriage 40 by applying the trapezoid driving profile to the carriage 40 that has entered the corresponding transport module 21.

In step S510, upon completion of application of all of the trapezoid driving profiles as the driving instruction transmitted from the upper control unit 10, the lower control unit 20 transmits a driving end signal to the upper control unit 10. In step S511, the upper control unit 10 receives the driving end signal from each lower control unit 20. In step S512, the upper control unit 10 transmits notification about completion of transport to the apparatus control unit 100.

The upper control unit 10 keeps transmitting the module transport instruction in step S507 as appropriate until receiving the driving end signal in step S511, which is until the end of driving of the corresponding carriage 40.

In step S513, the apparatus control unit 100 receives the notification about completion of transport from the upper control unit 10. In step S514, the apparatus control unit 100 transmits a control instruction to the process apparatus 110, and causes the process apparatus 110 to process the workpiece 43. In step S550, one cycle operation is completed in this manner. When one cycle operation is completed, the apparatus control unit 100 starts a next cycle operation (steps S501 to S550).

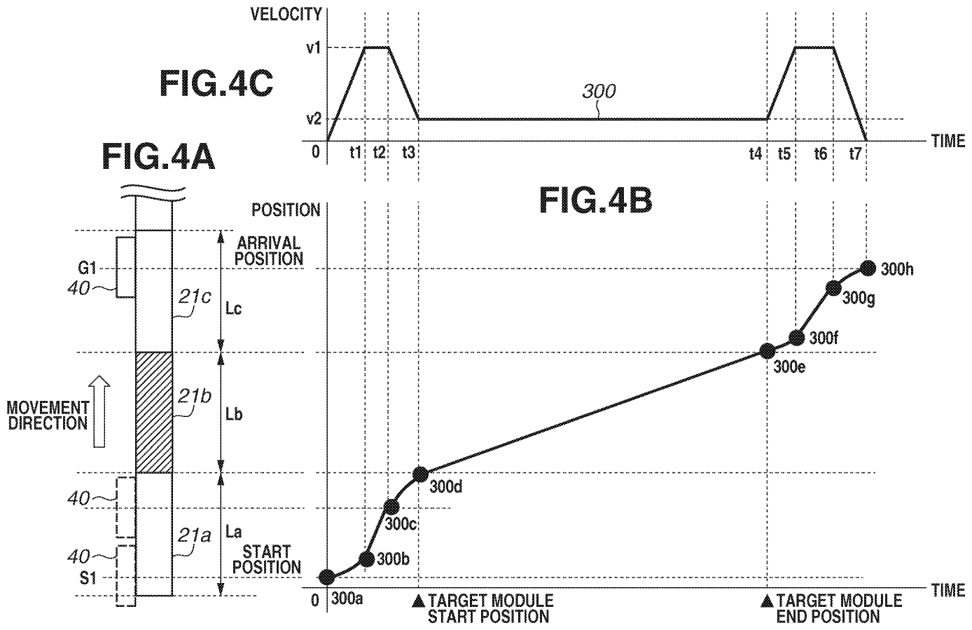

Subsequently, the generation of the driving profile according to the above-mentioned safe operation applicable range will be described in detail with reference to FIGS. 4A to 4C.

First, a method of transporting one carriage 40 between a plurality of transport modules 21 is described. FIG. 4A is a schematic configuration diagram illustrating transport of one carriage 40 among the three transport modules 21a to 21c. Additionally, FIG. 4B illustrates a profile of transporting the carriage 40 with the ordinate axis representing the X-position of the carriage 40 and the abscissa axis representing time t. FIG. 4C illustrates a profile regarding a velocity of the carriage 40 with the ordinate axis representing a velocity v of the carriage 40 and the abscissa axis representing time t.

The transport module 21b illustrated in FIG. 4A is the transport module 21 as a safe operation target, which is a target of being transported by the upper control unit 10 at a safe velocity.

In an example illustrated in FIG. 4A, a transport profile 300 is a transport profile to move the carriage 40 from a start position S1 to an arrival position G1 for time t7 using a transport velocity v1 and a transport velocity v2 that is lower than the transport velocity v1 through trapezoid driving. The transport profile 300 is composed of transport profiles 300a to 300h, and coordinate values are defined on an X axis of the global coordinate system. The transport velocity mentioned herein is an upper limit velocity in the transport profile. For example, the velocity may not necessarily reach the transport velocity in the transport profile in such a case where the velocity does not reach the upper limit velocity due to a short transport distance or the like.

The transport profile 300 is generated by the upper control unit 10. With this configuration, since the lower control units 20a to 20c that are respectively connected to the three transport modules 21a to 21c are involved in transport control of the carriage 40, the upper control unit 10 gives an instruction using the transport profile 300 on a relative coordinate system in consideration of module lengths La to Lc of the corresponding transport modules 21a to 21c.

In the present embodiment, the description is given of the example of the transport profile 300 in which the upper control unit 10 converts the position into that in the relative coordinate system and transmits an instruction to the lower control unit 20. However, the transport profile 300 is not limited thereto and it is sufficient only if the lower control unit 20 is capable of controlling the carriage 40 according to the transport profile 300 generated by the upper control unit 10.

The velocity v2 is a transport velocity that can implement safe operation, and a velocity setting preliminarily made in the upper control unit 10 may be used. Alternatively, an instructed velocity received from the apparatus control unit 100 may be used. In the present embodiment, the instructed velocity set in the upper control unit 10 is used. Assume that the same applies to an acceleration velocity and a deceleration velocity.

In the transport module 21a outside the safe operation applicable range, the carriage 40 is transported at the transport velocity v1 with use of the transport profile 300.

However, since the subsequent (downstream) transport module 21b is a target transport module of the safe operation applicable range, the transport velocity needs to become the transport velocity v2 before the leading end of the carriage 40 reaches the transport module 21b.

In a case where t3 is a time at which the carriage 40 reaches the transport module 21b, deceleration operation starts based on a preliminarily set deceleration from t2.

Thereafter, at t4 when the carriage 40 enters the transport module 21c after passing the transport module 21b, the transport is accelerated to the original transport velocity v1 again until time t5.

With this configuration, the transport can be performed based on a safe operation instruction. The description about the present embodiment is given assuming that the control profile is the trapezoid profile, but the control profile is not necessarily the trapezoid profile and may be a triangle driving profile when a distance is short. Additionally, the acceleration and the deceleration may not necessarily be equal. Furthermore, as a velocity profile, an S-curved profile or an appropriate setting from known profiles may be used.

As described above, setting a safe transport section according to the position of human work makes it possible to change the velocity to the safe operation velocity in a target range, which can prevent a decrease in production efficiency while human safety is taken into consideration of.

### Second Embodiment

A transport system according to a second embodiment of the present disclosure will be described. Components that are similar to those in the above-mentioned first embodiment are denoted by identical reference signs, and a description of the similar components is omitted as appropriate.

A configuration of a transport system 1 according to the present embodiment is basically similar to the configuration of the transport system 1 according to the first embodiment. The transport system 1 according to the present embodiment is different from the transport system 1 according to the first embodiment in that a switch unit configured to set a safe operation applicable range is provided in a transport module.

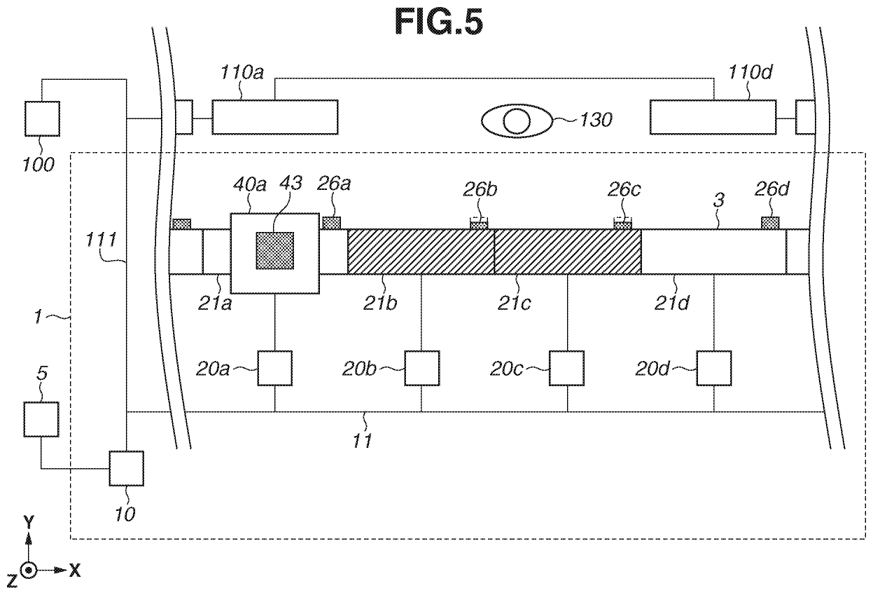

The switch unit configured to set the safe operation applicable range according to the second embodiment of the present disclosure will be described below with reference to FIG. 5.

FIG. 5 is a schematic diagram illustrating part of the transport system 1. The transport module 21 is provided with an operation mode setting unit 26. The operation mode setting unit 26 is installed on the surface of the transport module 21 so as to be easily accessible by the user. The operation mode setting unit 26 is disposed at a position easily accessible by the user for explanatory convenience, but may be covered with a cover or the like in terms of safety.

The operation mode setting unit 26 uses a switch capable of inputting ON/OFF in the present embodiment. The switch is a push button switch that holds a pressed state when the switch is pressed. A type of this switch is not specifically limited, and the switch is only required to be capable of creating a plurality of states such as a toggle switch, a rocker switch, or a dip switch.

In the present embodiment, a description is given that an operation mode setting unit 26b provided in the transport module 21b and an operation mode setting unit 26c provided in the transport module 21c are in an ON state. While the ON state is set as a request for safe operation in this example, an OFF state may be defined as the request for safe operation in consideration of a failure of the switch or the like.

The operation mode setting unit 26 is electrically connected to the lower control unit 20, and the lower control unit 20 is capable of constantly knowing the state of the operation mode setting unit 26. The lower control unit 20 notifies the upper control unit 10 of the state of the operation mode setting unit 26 as needed.

With this configuration, the notification given by the lower control unit 20 allows the upper control unit 10 to know the target transport module 21 that should fall in the safe operation applicable range.

The upper control unit 10 sets the safe operation applicable range based on information regarding the operation mode setting unit 26 from the lower control unit 20 in step S800.

As described above, according to the present embodiment, it is possible to switch the safe operation applicable range with the operation mode setting unit 26 provided in the transport module 21. This configuration makes it possible to change the velocity to the safe operation velocity in a target range, which can prevent a decrease in production efficiency while human safety is taken into consideration.

### Third Embodiment

A transport system according to a third embodiment of the present disclosure will be described. A component that is similar to that in each embodiment described above is denoted by an identical reference sign, and a description thereof is omitted as appropriate.

A configuration of a transport system 1 according to the present embodiment is basically similar to the configuration of the transport system 1 according to the first embodiment. The transport system 1 according to the present embodiment is different from the transport system 1 according to the first embodiment in setting of the safe operation applicable range from the console 5 as a user interface unit.

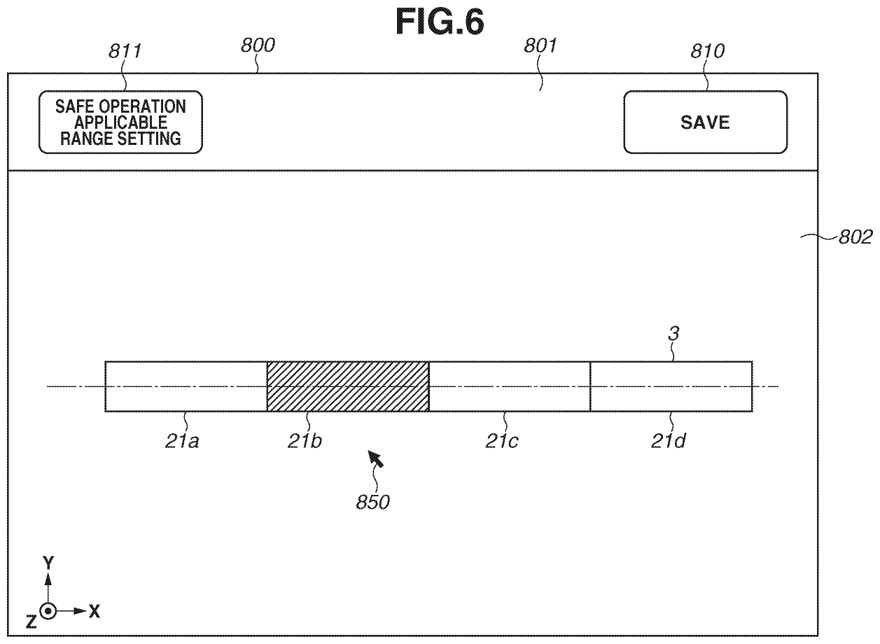

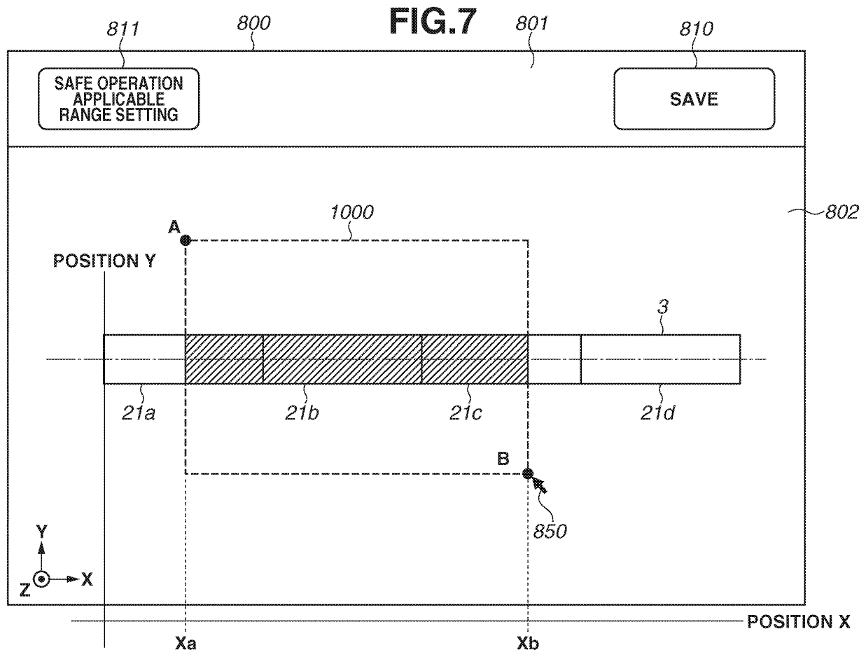

The third embodiment of the present disclosure will be described below with reference to FIGS. 6 and 7. First, the safe operation applicable range according to the present embodiment is described below with reference to FIG. 6. FIG. 6 illustrates a transport application 800 displayed in the console 5. The console 5 mentioned herein is a general personal computer (hereinafter referred to as PC) or the like, and may be, for example, a desktop PC or a tablet PC. In the present embodiment, the description is given assuming that the console 5 is the desktop PC. Assume that a general mouse and a general keyboard are connected to the PC as input interfaces.

The transport application 800 is configured to include a menu bar 801 and a drawing area 802 as a screen configuration. Additionally, a pointer 850 is operated and moved by the user with the mouse.

In the menu bar 801, function buttons for the transport application 800 are displayed. Buttons are used for explanatory convenience in the present embodiment, but a pull-down menu may be displayed from a menu item or a pop-up screen may be displayed.

In the drawing area 802, information regarding a transport path of the transport system 1 is displayed. In the present embodiment, setting is made so that the transport modules 21a to 21d constitute the transport unit 3. In the drawing area 802, there are a monitor mode in which only information regarding the transport system 1 is displayed and an edit mode for the user to make setting.

The menu bar 801 is provided with a save button 810. When the save button 810 is pressed, data created in the transport application 800 is transmitted to the upper control unit 10, and saved in the storage unit of the upper control unit 10. The saved data is referred to by the upper control unit 10 as needed. Although a description is omitted in the present embodiment for explanatory convenience, the user may be prompted to save data by a pop-up window with display of an OK button or a cancel button to prevent erroneous operation.

When a safe operation applicable range setting button 811 in the menu bar 801 is pressed, the drawing area 802 is shifted to the edit mode. In this state, the user selects the transport module 21 in which the user wants to set the safe operation applicable range using the pointer 850. The safe operation applicable range setting button 811 may notify the user of in which mode the drawing area 802 is currently operated.

When the transport module 21 is selected as the safe operation applicable range, the display of the drawing area 802 is changed so that the transport module 21 is selected like the transport module 21b. At this time, the transport module 21b is hatched, but any drawing method may be used as long as a difference from unselected transport modules 21 can be seen such as drawing using color or blinking.

When ending selection of the safe operation applicable range, the user presses the save button 810 to reflect a content of the setting. With this configuration, the setting regarding the safe operation applicable range is transmitted to the upper control unit 10. The upper control unit 10 uses this range as the safe operation applicable range in step S800 based on the transmitted content.

Subsequently, the safe operation applicable range that is set based on selection of an optional range will be described with reference to FIG. 7. The pointer 850 in FIG. 7 indicates drawing that the user has performed operation while selecting the safe operation applicable range from a point A to a pint B. A rectangular parallelepiped drawn at this time is recognized as a safe operation range 1000.

The transport unit 3 drawn inside the safe operation range 1000 is set as the safe operation applicable range. The safe operation range 1000 represents a range from Xa to Xb in the global coordinate system with a zero position of the transport module 21a in the X-axis direction serving as a reference.

This safe operation applicable range is transmitted to the upper control unit 10 by pressing of the save button 810, whereby the upper control unit 10 uses the range as the safe operation applicable range in step S800.

As described above, according to the present embodiment, it is possible for the user to preliminarily set the safe operation applicable range from the console 5. This configuration makes it possible to change the velocity to the safe operation velocity in a freely selected range, which can prevent a decrease in production efficiency while taking into consideration of human safety.

### Fourth Embodiment

A transport system according to a fourth embodiment of the present disclosure will be described. A component that is similar to that in each embodiment described above is denoted by an identical reference sign, and a description thereof is omitted as appropriate.

A configuration of a transport system 1 according to the present embodiment is basically similar to the configuration of the transport system 1 according to the first embodiment. The transport system 1 according to the present embodiment is different from the transport system 1 according to the first embodiment in setting of the safe operation applicable range depending on a position of an operator.

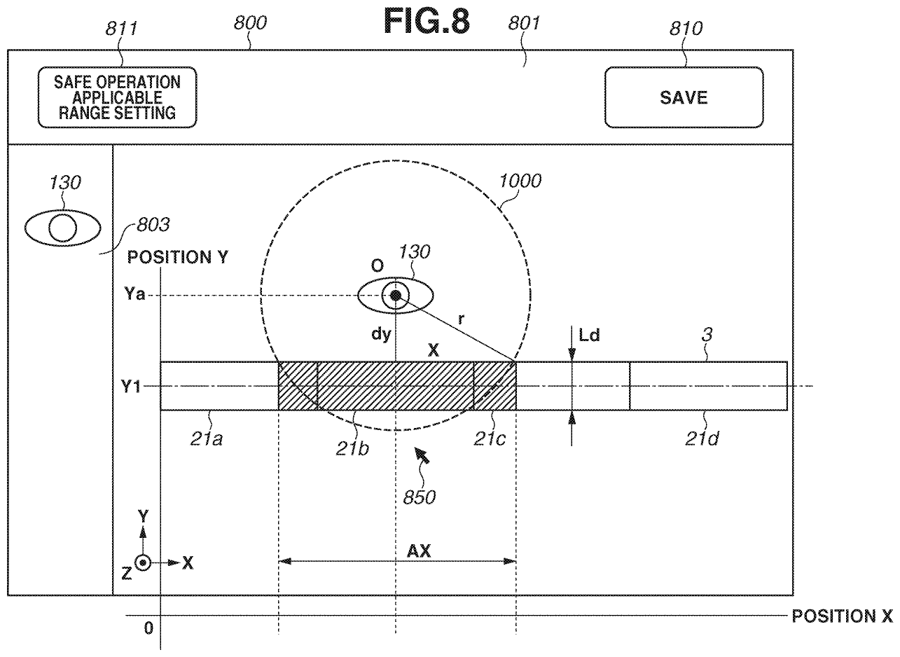

The fourth embodiment of the present disclosure will be described below with reference to FIG. 8. FIG. 8 is a schematic diagram illustrating a transport application 800 according to the present embodiment. The transport application 800 is different from the transport application 800 according to the third embodiment in inclusion of an object area 803 in addition to the menu bar 801 and the drawing area 802.

In the object area 803, objects associated with the transport system 1 are preliminarily registered, and the safe operation range 1000 is held as information in these objects.

In the present embodiment, an operator 130 is registered in the object area 803. The user uses the pointer 850 to drag and drop the operator 130 as the object in the object area 803 to an appropriate position. With this operation, it is drawn to indicate that the operator 130 performs work near the transport unit 3 in the transport system 1. At this time, the operator 130 is disposed at positions Xa and Ya.

Subsequently, a description is given of the safe operation range 1000 that is drawn as a circle with a radius r from the center O of the operator 130. The radius r represents a movable range of the operator 130. The radius r may be preliminarily set, or a freely selected numeric value may be input and set from a pop-up window or the like. At this time, assume that X-axis positions of intersection points between the safe operation range 1000 and the transport unit 3 are X1 and X2.

Subsequently, a shortest distance dy from the operator 130 to the transport unit 3 is described. The shortest distance dy represents a distance to a side surface of the transport module 21b. The transport unit 3 is installed at a position Y1, and the transport module 21 has a width Ld. Hence, the shortest distance dy is expressed by the following Expression (1).

$$dy = Ya - Y 1 + Ld / 2 \qquad ( 1 )$$

A distance X can be obtained by the following Expression (2) using the radius r and the shortest distance dy obtained by the above-mentioned Expression (1).

$$X = √ ( r \hat{} 2 - dy \hat{} 2 ) \qquad ( 2 )$$

As a result, a start point X1 and an end point X2 can be obtained by the following Expressions (3) and (4).

$$X 1 = Xa - X \qquad ( 3 )$$

$$X 2 = Xa + X \qquad ( 4 )$$

As a result, a safe operation applicable range AX can be obtained as a range from the start point X1 to the end point X2.

This safe operation applicable range is transmitted to the upper control unit 10 by pressing of the save button 810, whereby the upper control unit 10 uses this range as the safe operation applicable range in step S800.

The description has been given assuming that the safe operation range has a circular shape, but the shape thereof is not limited thereto and may be, for example, a shape that is extended in a direction of work by the operator 130, as an elliptic shape.

As described above, according to the present embodiment, it is possible to set the safe operation applicable range in consideration of the position of the operator 130. This configuration makes it possible to prevent a decrease in production efficiency while taking into consideration of human safety.

The present disclosure is not limited to the above-mentioned embodiments and can be modified in various manners.

For example, in each embodiment described above, the description has been given of the example of the movable magnet type in which the carriage 40 includes the permanent magnet 42 and is driven by electromagnetic force generated between the carriage 40 and the coil group 23 attached to the transport module 21, but the configuration is not limited thereto. A mode in which the permanent magnet 42 is provided in the transport module 21 and the coil group 23 is provided in the carriage 40, that is, the movable coil type, may be employed.

Additionally, for example, the transport system 1 according to the present disclosure can be used, in a manufacturing system that manufactures a product such as an electronic device, as a transport system that transports a workpiece to a work area of each process apparatus that performs each work process on a workpiece that becomes the product. The process apparatus that performs the work process may be any apparatus such as an apparatus that assembles a component into the workpiece, an apparatus that performs painting, or the like. Additionally, the product to be manufactured is not limited to a specific product, and may be any product.

Additionally, a control program capable of executing the above-mentioned control method and a computer-readable recording medium that stores the control program are also included in embodiments of the present disclosure. As the recording medium to supply the control program, for example, a read-only memory (ROM), a disk, an external storage apparatus, or the like may be used. As specific examples of a computer-readable non-transitory recording medium, a non-volatile memory such as a flexible disk, an optical disk, a magnetic optical disk, or a magnetic tape, or a universal serial bus (USB) memory, and a solid state drive (SSD) can be used.

Additionally, the present disclosure can also be implemented by installation of a program that implements one or more functions of the above-mentioned embodiments in a system or an apparatus via a network or a storage medium, and processing of loading and executing the program by one or more processors in the system or a computer of the apparatus. Furthermore, the present disclosure can also be implemented by a circuit (for example, an application specific integrated circuit (ASIC)) that implements one or more functions.

The advantageous effects described in each embodiment are merely listing of the most favorable effects derived from the technique of the present disclosure, and the advantageous effects according to the technique of the present disclosure are not limited to the above-mentioned advantageous effects.

The disclosure of the embodiments includes the following configurations.

### (Item 1)

A transport system including a movable element; a transport unit including a plurality of transport modules; and a control unit configured to control the movable element along the transport unit, in which a transport velocity to transport the movable element is set in each of the plurality of transport modules, and the control unit is configured to generate a control profile for the movable element based on the transport velocity for each of the plurality of transport modules.

### (Item 2)

The transport system according to Item 1, in which the control unit is configured to generate the control profile with the transport velocity serving as an upper limit velocity.

### (Item 3)

The transport system according to Item 2, in which the plurality of transport modules includes a first transport module and a second transport module that is adjacent to the first transport module and that is lower in the transport velocity than the first transport module, and the control unit is configured to generate the control profile so as to decelerate transport to the transport velocity set in the second transport module before the movable element reaches the second transport module.

### (Item 4)

The transport system according to Item 2, in which the control profile represents trapezoidal driving.

### (Item 5)

The transport system according to any one of Items 1 to 4, further including a user interface unit, in which the transport velocity is set in each of the plurality of transport modules based on operation by a user on the user interface unit.

### (Item 6)

The transport system according to Item 5, in which the operation is input of a position of an operator to the user interface unit, and the transport velocity is set based on the input position of the operator and positions of the plurality of transport modules.

### (Item 7)

The transport system according to Item 5, in which the operation is input of a safe operation range to the user interface unit, and a transport velocity for the transport module included in the safe operation range, out of the plurality of transport modules, is lower than a transport velocity for a transport module not included in the safe operation range.

### (Item 8)

The transport system according to Item 5, in which the operation is arrangement of a plurality of objects associated with the transport system in the user interface unit, in each of the plurality of objects, a safe operation range including a corresponding object is set, and a transport velocity for the transport module included in the safe operation range, out of the plurality of transport modules, is lower than a transport velocity for a transport module not included in the safe operation range.

### (Item 9)

The transport system according to any one of Items 1 to 4, further including a switch unit provided in each of the plurality of transport modules, in which the transport velocity is set in each of the plurality of transport modules based on input to the switch unit.

### (Item 10)

The transport system according to any one of Items 1 to 9, in which one of each transport module and the movable element includes a coil, and the other of each transport module and the movable element, the other not including the coil, includes a permanent magnet.

### (Item 11)

A manufacturing system including the transport system according to any one of Items 1 to 10; and an apparatus configured to perform work on a workpiece transported by the transport system.

### (Item 12)

A method of controlling a transport system, the transport system including a movable element; a transport unit including a plurality of transport modules; and a control unit configured to control the movable element along the transport unit, the method including setting a transport velocity to transport the movable element in each of the plurality of transport modules; and generating a control profile for the movable element based on the transport velocity for each of the plurality of transport modules.

### (Item 13)

A method of manufacturing a product, the method including transporting a workpiece constituting the product by the method according to Item 12; and performing work on the workpiece.

### (Item 14)

A program to cause a computer to execute the method according to Item 12.

### (Item 15)

A non-transitory computer-readable recording medium that stores the program according to Item 14.

According to the present disclosure, it is possible to prevent a decrease in production efficiency while taking into consideration of human safety in a production line including human work.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-054119, which was filed on Mar. 27, 2025 and which is hereby incorporated by reference herein in its entirety.

What is claimed is:

1. A transport system comprising:
a movable element;
a transport unit including a plurality of transport modules; and
a control unit configured to control the movable element along the transport unit,
wherein a respective transport velocity to transport the movable element is set in each of the plurality of transport modules, and
wherein the control unit is configured to generate a control profile for the movable element based on the respective transport velocity set in each of the plurality of transport modules.

2. The transport system according to claim 1, wherein the control unit is configured to generate the control profile with the respective transport velocity set in each of the plurality of transport modules serving as an upper limit velocity.

3. The transport system according to claim 2,
wherein the plurality of transport modules includes a first transport module and a second transport module that is adjacent to the first transport module,
wherein the respective transport velocity set in the second transport module is lower than the respective transport velocity set in the first transport module, and
wherein the control unit is configured to generate the control profile so as to decelerate transport to the respective transport velocity set in the second transport module before the movable element reaches the second transport module.

4. The transport system according to claim 2, wherein the control profile represents trapezoidal driving.

5. The transport system according to claim 1,
further comprising a user interface unit,
wherein the respective transport velocity is set in each of the plurality of transport modules based on operation by a user on the user interface unit.

6. The transport system according to claim 5,
wherein the operation is input of a position of an operator to the user interface unit, and
wherein the respective transport velocity is set in each of the plurality of transport modules based on the input position of the operator and respective positions of the plurality of transport modules.

7. The transport system according to claim 5,
wherein the operation is input of a safe operation range to the user interface unit, and
wherein the respective transport velocity for a transport module included in the safe operation range, out of the plurality of transport modules, is lower than the respective transport velocity for a transport module not included in the safe operation range, out of the plurality of transport modules.

8. The transport system according to claim 5,
wherein the operation is an arrangement of a plurality of objects associated with the transport system in the user interface unit,
wherein, in each of the plurality of objects, a respective safe operation range including a corresponding object is set, and
wherein the respective transport velocity for a transport module included in the safe operation range, out of the plurality of transport modules, is lower than the respective transport velocity for a transport module not included in the safe operation range, out of the plurality of transport modules.

9. The transport system according to claim 1, further comprising a respective switch unit provided in each of the plurality of transport modules,
wherein the respective transport velocity is set in each of the plurality of transport modules based on input to the switch unit.

10. The transport system according to claim 1,
wherein either the plurality of transport modules each include a respective coil or the movable element includes a respective coil, and
wherein the other of the plurality of transport modules and the movable element, the other not including the coil, includes a permanent magnet.

11. A manufacturing system comprising:
the transport system according to claim 1; and
an apparatus configured to perform work on a workpiece transported by the transport system.

12. A method of controlling a transport system, the transport system including a movable element, a transport unit including a plurality of transport modules, and a control unit configured to control the movable element along the transport unit, the method comprising:
setting a respective transport velocity to transport the movable element in each of the plurality of transport modules; and
generating a control profile for the movable element based on the respective transport velocity for each of the plurality of transport modules.

13. A method of manufacturing a product comprising:
transporting a workpiece constituting the product by the method according to claim 12; and
performing work on the workpiece.

14. A non-transitory computer-readable medium that stores computer-executable instructions for causing a computer to execute a method, the method comprising:
setting a respective transport velocity to transport the movable element in each of the plurality of transport modules; and
generating a control profile for the movable element based on the respective transport velocity for each of the plurality of transport modules.
